(19) United States
(12) Patent Application Publication
(10) Pub. No.: US 2008/0118680 A1
(43) Pub. Date: May 22, 2008

(54) AIR ENCLOSURE WITH INDEPENDENT DOUBLE LAYER AIR CHAMBERS

(75) Inventors: CHIAN HUA LIAO, Sindian City (TW); YAO SIN LIAO, Sindian City (TW); YAO CHUAN LIAO, Sindian City (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: YAO SIN LIAO, Sindian City (TW)

(21) Appl. No.: 11/753,415

(22) Filed: May 24, 2007

(30) Foreign Application Priority Data
Nov. 17, 2006 (TW) 095142730

(51) Int. Cl. B29D 22/00

(52) U.S. Cl. 428/34.1

(57) ABSTRACT

An air enclosure with independent double layer air chambers is constituted by disposing a middle film between a first outer film and a second outer film which are folded together, in which the length of the middle film is shorter than the first outer film and the second outer film, and the lower sides of the three parties are lined up with one another to allow an air filling passageway to be formed on one common end of the first outer film and the second outer film by means of hot sealing and in the meantime, a first air inlet and a plurality of first air chambers to be formed by adhering the first outer film to the middle film and a second air inlet and a plurality second air chambers to be formed by adhering the middle film to the second outer film. When the air in the air filling passageway is filled into the first air chamber to cause it to be expanded via the first air inlet and in the meantime, filled into the second air chamber to cause it to be expanded via the second air inlet, and when any one of the first air chamber and the second air chamber is broken, the another can provide the cushioning protection effect.

### CROSS-REFERENCES TO RELATED APPLICATIONS

This non-provisional application claims priority under 35 U.S.C. § 119(a) on Patent Application No. 095142730 filed in Taiwan, R.O.C. on 2006 Nov. 17, the entire contents of which are hereby incorporated by reference.

### FIELD OF THE INVENTION

The present invention relates to an air enclosure, and more particularly to an air enclosure with independent double layer air chambers.

### BACKGROUND

A conventional way for packing an article with a cushioning agent mostly is wrapping around the article with a plastic sheet on which a plurality of small raised air bags are projected to attain to the shock-absorbed cushioning functions. But the shock absorption capability of the small air bags is limited such that the cushioning and the shock absorption effects to a larger shock or impulse cannot be attained. Therefore, an air packing bag is developed to take as a wrapping cushioning means

However, the air bag made from polyethylene (PE) is easy to be pierced through by a sharp acute angle of a packed article or an adjoining angle of hardware; once a small broken hole appears on the air packing bag, fluid in the air packing bag is then leaked out. For example, in The U.S. Pat. No. 4,850,912 entitled as “Container for sealingly containing a fluid”, The U.S. Pat. No. 5,261,466 entitled as “Process for continuously filling fluid into a plurality of closed bags”, each air cylinder of the air packing bag disclosed by them is disposed with an independent check valve, it is limited to the air cylinder on which the broken hole is yielded leaks air, and is not to cause other unbroken air cylinders to leak air when parts of the air cylinders are broken. Although such structure does not cause the whole air to be leaked due to the damage of the parts of the air cylinders, but the broken air cylinders will lose the cushioning protection effect; it is easy to cause a packed article to be damaged or scratched.

Therefore, for not only improving a structure of an air packing bag, but also solving the problem that the parts of the air cylinders are broken to cause the air to be leaked out and hence, the air packing bag loses the cushioning protection function, the present invention is proposed.

### SUMMARY OF THE INVENTION

For improving the deficits mentioned above, the present invention proposes an air enclosure, with independent double layer air chambers, it comprises a first outer film, a second outer film, a middle film, an air filling passageway, a plurality of first air chambers, at least one first air inlet, a plurality of second air chambers and at least one second air inlet, in which the second outer film is stacked together with the first outer film; the middle film is disposed between the first and the second outer films, the length thereof is shorter than the first outer and the second outer films and one side of the middle film is lined up with one side of the first outer film and one side of the second outer film; the air filling passageway is an air passable space formed by adhering the first outer film and the second outer film by means of hot sealing; each first air chamber is positioned at one side of the air filling passageway and is an air storable space formed by adhering the first outer film and the middle film by means of hot sealing; the first air inlet is formed between the first outer film and the middle film and used for communicating the air filling passageway with the first air chamber; each second air chamber is positioned at one side of the air filling passageway and is an air storable space formed by adhering the second outer film and the middle film by means of hot sealing; the second air inlet is formed between the second outer film and the middle film and used for communicating the air filling passageway with the second air chamber.

The present invention proposes another air enclosure with independent double layer air chambers, it comprises a first outer film, a second outer film, a middle film, at least one first inner film, at least one second inner film, an air filling passageway, a plurality of first air chambers, at least one first air inlet, a plurality of second air chambers and at least one second air inlet, in which the second outer film is stacked together with the first outer film; the middle film is disposed between the first and the second outer films, the length thereof is shorter than the first outer and the second outer films and one side of the middle film is lined up with one side of the first outer film and one side of the second outer film; the first inner film is positioned between the first outer film and the middle film; the second inner film is positioned between the middle and the second outer films; the air filling passageway is an air passable space formed by adhering the first inner film and the second inner film by means of hot sealing; each first air chamber is positioned at one side of the air filling passageway and is an air storable space formed by adhering the first outer film and the middle film by means of hot sealing; the first air inlet is formed between the first outer film and the middle film and used for communicating the air filling passageway with the first air chamber; each second air chamber is positioned at one side of the air filling passageway and is an air storable space formed by adhering the second outer film and the middle film by means of hot sealing; the second air inlet is formed between the second outer film and the middle film and used for communicating the air filling passageway with the second air chamber.

According to the structure mentioned above, the first air chamber and the second air chamber are opposite to each other and the volume of the first air chamber is the same as the volume of the second air chamber.

Besides, a cutting zone is disposed on the air filling passageway according to the present invention, cutting along the cut area to cause the first air chamber and the second air chamber to be separated to enable the output of the air enclosures to be doubled.

After air is filled in the air filling passageway, the air in the air filling passageway is filled into the first air chamber via the first air inlet to cause the first air chamber to be expanded an in the meantime, filled into the second air chamber via the second air inlet to cause the second air chamber to be expanded, thereby, not only the air filling speed of both the first and the second air chambers can be faster but also when one of the first and the second air chambers is broken, the another can be allowed to provide the cushioning protection to maintain the shock absorbing cushioning capability.

### BRIEF DESCRIPTION OF THE DRAWINGS

The present invention can be more fully understood by reference to the following description and accompanying drawings, in which:

FIG. 1 is a plane view, showing an air enclosure with independent double layer air chambers before air filling of a first preferred embodiment according to the present invention;

FIG. 2 is a cross sectional view, showing an air enclosure with independent double layer air chambers after air filling of a first preferred embodiment according to the present invention;

FIG. 3 is a cross sectional view, showing an air enclosure with independent double layer air chambers after air filling of a first preferred embodiment according to the present invention;

FIG. 4 is a cross sectional view, showing an air enclosure with independent double layer air chambers after air filling of a second preferred embodiment according to the present invention;

FIG. 5 is a cross sectional view, showing an air enclosure with independent double layer air chambers after air filling of a second preferred embodiment according to the present invention;

FIG. 6 is a plane view, showing an air enclosure with independent double layer air chambers before air filling of a third preferred embodiment according to the present invention;

FIG. 7 is a cross sectional view, showing an air enclosure with independent double layer air chambers after air filling of a third preferred embodiment according to the present invention;

FIG. 8 is a cross sectional view, showing an air enclosure with independent double layer air chambers after air filling of a third preferred embodiment according to the present invention;

FIG. 9 is a cross sectional view, showing an air enclosure with independent double layer air chambers after air filling of a fourth preferred embodiment according to the present invention;

FIG. 10 is a cross sectional view, showing an air enclosure with independent double layer air chambers after air filling of a fifth preferred embodiment according to the present invention;

FIG. 11 is a cross sectional view, showing an air enclosure with independent double layer air chambers after air filling of a sixth preferred embodiment according to the present invention;

FIG. 12 is a cross sectional view, showing an air enclosure with independent double layer air chambers after air filling of a sixth preferred embodiment according to the present invention;

FIG. 13 is a plane view, showing an air enclosure with independent double layer air chambers before air filling of a seventh preferred embodiment according to the present invention;

FIG. 14 is a cross sectional view, showing an air enclosure with independent double layer air chambers after air filling of a seventh preferred embodiment according to the present invention;

FIG. 15 is a cross sectional view, showing an air enclosure with independent double layer air chambers after air filling of a seventh preferred embodiment according to the present invention;

FIG. 16 is a cross sectional view, showing an air enclosure with independent double layer air chambers after air filling of a eighth preferred embodiment according to the present invention;

FIG. 17 is a plane view, showing an air enclosure with independent double layer air chambers before air filling of a ninth preferred embodiment according to the present invention; and

FIG. 18 is a cross sectional view, showing an air enclosure with independent double layer air chambers after air filling of a ninth preferred embodiment according to the present invention.

### DETAILED DESCRIPTION OF THE PREFERRED EMBODIMENTS

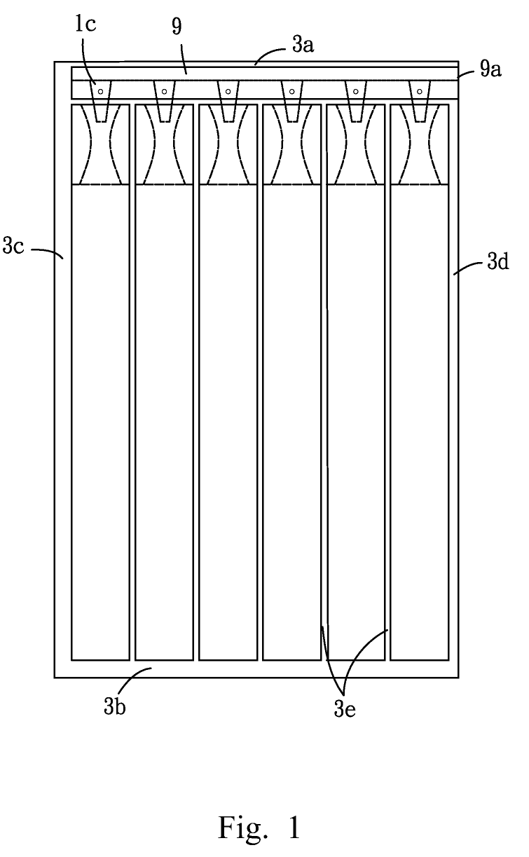

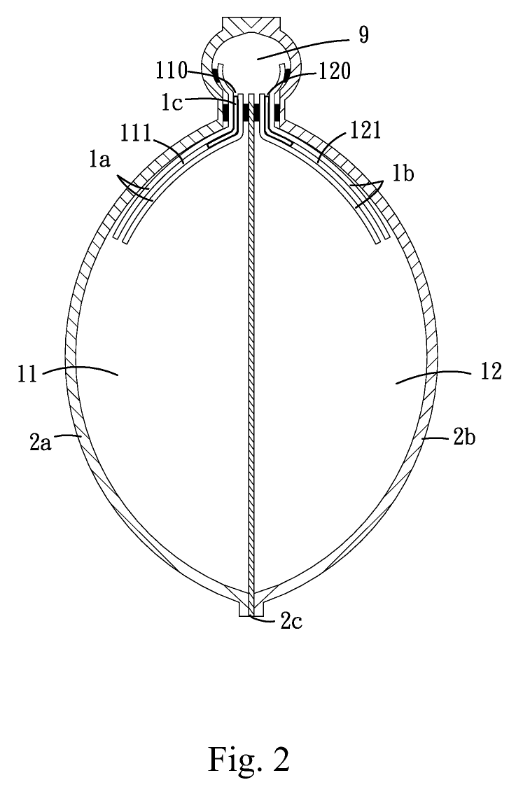

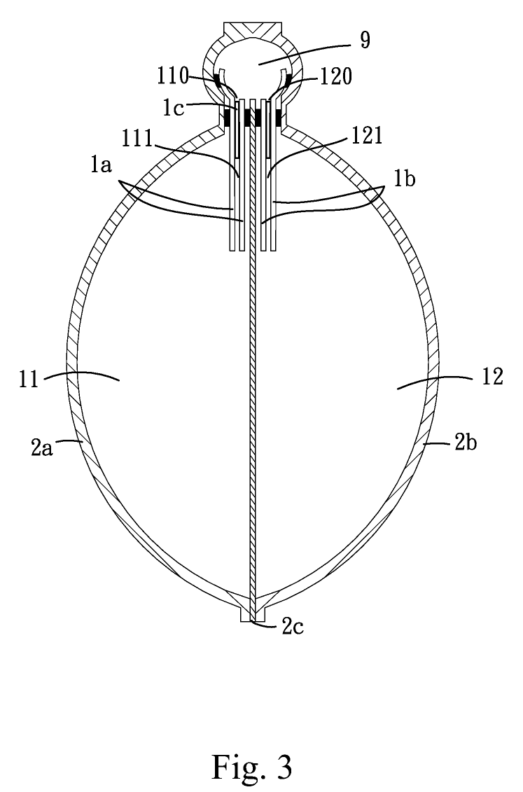

Please refer to FIGS. 1 to 3. FIG. 1 is a plane view, showing an air enclosure with independent double layer air chambers before air filling of a first preferred embodiment according to the present invention. FIG. 2 is a cross sectional view, showing an air enclosure with independent double layer air chambers after air filling of a first preferred embodiment according to the present invention. FIG. 3 is a cross sectional view, showing an air enclosure with independent double layer air chambers after air filling of a first preferred embodiment according to the present invention.

An air enclosure with independent double layer air chambers comprises a first outer film 2a, second outer film 2b, middle film 2c, first inner film 1a, second inner film 1b, air filling passageway 9, first air chamber 11 and second air chamber 12.

The first and the second outer films 2a and 2b are folded together vertically.

The middle film 2c is disposed between the first outer film 2a and the second outer film 2b, the length of the middle film 2c is shorter than the first outer film 2a and the second outer film 2b and the lower side of the middle film 2c is lined up with the lower sides of the first outer film 2a and the second outer film 2b.

Two first inner films 1a are positioned between the first outer film 2a and the middle film 2c, and the upper sides of the first inner films 1a are lined up with the upper side of the middle film 2c.

Two second inner films 1b are positioned between the middle film 2c and the second outer film 2b, and the upper sides of the second inner films 1b are lined up with the upper side of the middle film 2c

Hot sealing is processed along hot sealing lines 3a, 3b, 3c and 3d so as to adhere the first outer film 2a, the second outer film 2b, the middle film 2c, the two first inner films 1a and the two second inner films 1b to cause the air-passable air filling passageway 9 to be formed between the first outer film 2a and the second outer film 2b to allow the air filling passageway 9 to be positioned on one common end of the first outer film 2a and the second outer film 2b in which the air filling passageway 9 comprises an air filling entrance 9a opened to outside air. Furthermore, the hot sealing mentioned above can be hot mold pressing.

The air storable first air chamber 11 is caused to form between the first outer film 2a and the middle film 2c and the air storable second air chamber 12 is formed between the middle film 2c and the second outer film 2b after hot sealing is processed, in which the first air chamber 11 is disposed oppositely to the second air chamber 12 and the volume of the first air chamber 11 is the same as the volume of the second air chamber 12.

A heat resistant material 1c is spread sequentially and separately between the two first inner films 1a, e.g. heat resistant rubber or ink is printed. The two first inner films 1a are still not adhered to each other to form an air inlet 110 and a first air passageway 111 connected to the first air inlet 110 used for communicating the air filling passageway 9 and the first air chamber after hot sealing is processed. Here, the first air passageway 111 is a hot-sealing curve type and the width of one end of the first air passageway 111 connected to the first air inlet 110 is larger than the width of another end thereof, and the air pressure in a curved portion of the air passageway 111 is larger than the air pressure in two sides thereof to allow the air in the first air inlet 110 to enter easily and escape out uneasily. The curved portion of the first air passageway 111 is thrust tightly to attain to the air locking effect when the inner air pressure in the first air chamber increases. Furthermore, the first air passageway 111 can also be a multiple dots type, double curve type or straight line type air flowing route. Besides, a second air inlet 120 and a second air passageway 121 having the same structures are formed between the two second inner films 1b and used for communicating the air filling passageway 9 with the second air chamber 12.

The air entering the air filling entrance 9a expands the air filling passageway 9 to cause the two first inner films 1a to be pulled outward to open each first air inlet 110 and in the meantime, cause the two inner films 1b to be pulled outward to open each second air inlet 120, thereby the air in the air filling passageway 9 can be used to fill each first air chamber 11 and each second air chamber 12 with air to allow each first air chamber 11 and each second air chamber 12 to be filled with air and expanded. Thus, the inner air pressure of the first air chamber 11 presses the two first inner films 1a to attach closely onto the first outer film 2a or the middle film 2c to cover the first air passageway 111 and hence, seal the first air chamber 11. Similarly, the inner air pressure of the second air chamber 12 presses the two second inner films 1b to attach closely onto the middle film 2c or the second outer film 2b to cover the second air passageway 121 and hence, seal the second air chamber 12. Whereby, the air in the first air chamber 11 and the second air chamber 12 are allowed not to be leaked out thereby attaining to the air locking effect.

Therefore, not only the air filling speed of the first air chamber 11 and the second air chamber 12 can be faster such that the time required for the air filling can be shortened, but also when one of the first air chamber 11 and the second air chamber 12 is broken, the another one is allowed not to influence and to maintain in an airtight state to continue providing the cushioning protection and maintain the shock absorbed cushioning capability because the first air chamber 11 and the air chamber 12 are independent to each other.

When the aforementioned two first inner films 1a is subject to the thrust of the inner air pressure of the first air chamber 11, the first inner films 1a might be attached closely onto the first outer film 2a or the middle film 2c, and might not be side-attached onto the first outer film 2a or the middle film 2c but become a double sheet cantilever type air enclosure and similarly, when the two second inner films 1b is subject to the thrust of the inner air pressure of the second air chamber 12, the second inner films 1b might be attached closely onto the middle film 2c or the first outer film 2a, and might not be side-attached onto the middle film 2c or the second outer film 2b but become a double sheet cantilever type air enclosure.

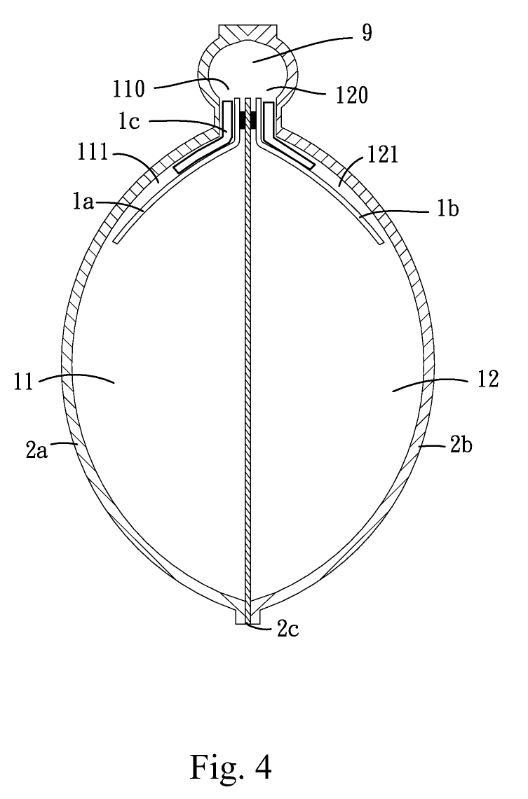

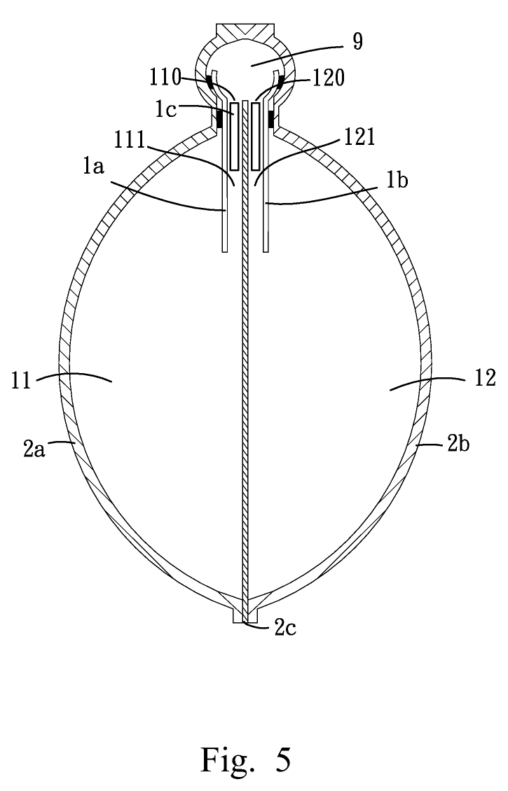

Please refer to FIGS. 4 and 5. FIG. 4 is a cross sectional view, showing an air enclosure with independent double layer air chambers after air filling of a second preferred embodiment according to the present invention. FIG. 5 is a cross sectional view, showing an air enclosure with independent double layer air chambers after air filling of a second preferred embodiment according to the present invention.

One first inner film 1a is disposed between the first outer film 2a and the middle 2c, and the upper side of the first inner film 1a is lined up with the upper side of the middle film 2c and similarly, one second inner film 1b is disposed between the middle film 2c and the second outer film 2b, and the upper side of the second inner film 1b is lined up with the upper side of the middle film 2c.

A heat resistant material 1c is spread on one face of the first inner film 1a to allow it not to be adhered to other films to form the first air inlet 110 and the first air passageway 111 connected to the first air inlet 110 used to communicate the air filling passageway 9 with the first air chamber 11 even by means of hot sealing, in which the first air passageway 111 is a hot-sealing curve type, the width of one end of the first air passageway 111 connected to the first air inlet 110 is larger than the width of another end thereof, and the air pressure in a curved portion of the first air passageway 111 is larger than the air pressure in two sides thereof to cause the air in the first air inlet 110 to enter easily and escape out uneasily; when the inner pressure in the first air chamber 11 increases, it thrusts the curved portion tightly to attain to the air locking effect. Moreover, the first air passageway 111 can also be a multiple dots type, double curve type or straight line type air progression route. Similarly, the second air inlet 120 and the second air passageway 121 having the same structure are also formed after one face of the second inner film 1b is spread with the heat resistant material 1c and used for communicating the air passageway 9 and the second air chamber 12.

The air entering the air filling entrance 9a expands the air filling passageway 9 to cause the first inner films 1a to be pulled outward to open each first air inlet 110 and in the meantime, cause the inner film 1b to be pulled outward to open each second air inlet 120, thereby the air in the air filling passageway 9 can be used to fill each first air chamber 11 and each second air chamber 12 with air to allow each first air chamber 11 and each second air chamber 12 to be filled with air and expanded. Thus, the inner air pressure of the first air chamber 11 presses the first inner films 1a to attach closely onto the first outer film 2a or the middle film 2c to cover the first air passageway 111 and hence, seal the first air chamber 11. Similarly, the inner air pressure of the second air chamber 12 presses the second inner films 1b to attach closely onto the middle film 2c or the second outer film 2b to cover the second air passageway 121 and hence, seal the second air chamber 12. Whereby, the air in the first air chamber 11 and the second air chamber 12 are allowed not to be leaked out to attain to the air locking effect.

According to the structure disclosed by the present invention, a heat resistant material 1c is spread on one face of the first inner film 1a close to the first outer film 2a, the first inner film 1a is still not adhered to the first outer film 2a to form the first air inlet 110 even by means of hot sealing, and the inner air pressure in the first air chamber 11 thrusts the first inner film 1a to attach closely onto the first outer film 2a to cover the first air passageway 111 to seal the first air chamber 11 and similarly, a heat resistant material 1c is spread on one face of the first inner film 1a close to the middle film 2c, the first inner film 1a is still not adhered to the middle film 2c to form the first air inlet 110 even by means of hot sealing, and the inner air pressure in the first air chamber 11 thrusts the first inner film 1a to attach closely onto the middle film 2c to cover the first air passageway 111 to seal the first air chamber 11

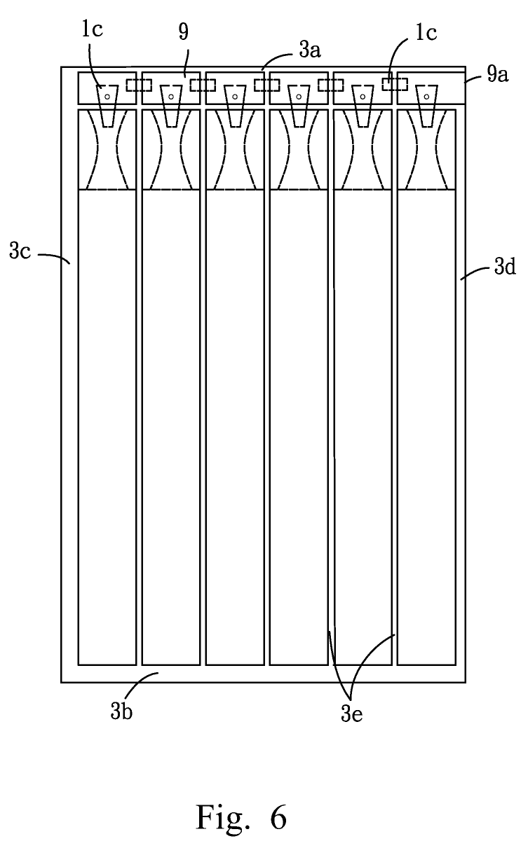

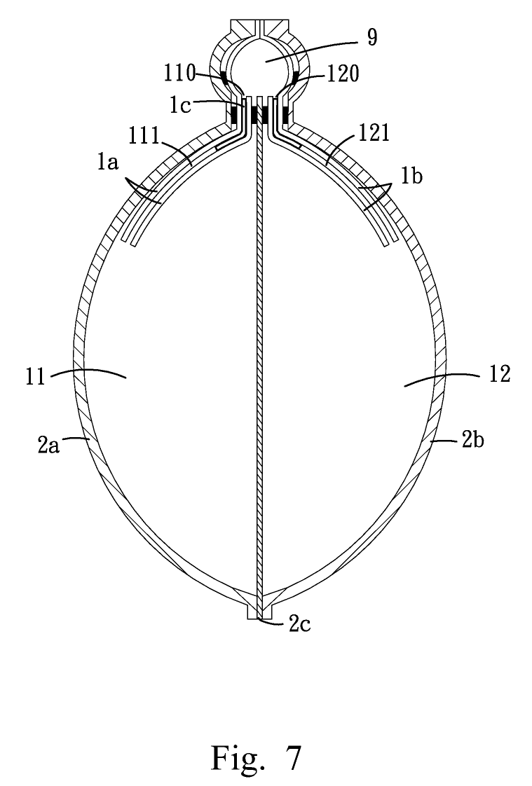

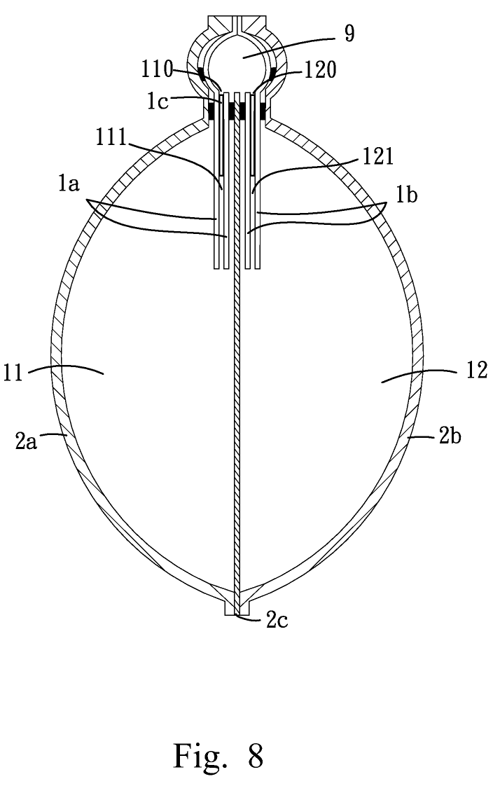

please refer to FIGS. 6, 7 and 8. FIG. 6 is a plane view, showing an air enclosure with independent double layer air chambers before air filling of a third preferred embodiment according to the present invention. FIG. 7 is a cross sectional view, showing an air enclosure with independent double layer air chambers after air filling of a third preferred embodiment according to the present invention. FIG. 8 is a cross sectional view, showing an air enclosure with independent double layer air chambers after air filling of a third preferred embodiment according to the present invention;

Two first inner films 1a are disposed between the first outer film 2a and the middle film 2c, and the upper side of the first inner film 1a positioned closer to the first outer film 2a is lined up with the upper side of the first outer film 2a and similarly, two second inner films 1b are disposed between the middle film 2c and the second outer film 2b, and the upper side of the second inner film 1b positioned closer to the second outer film 2b is lined up with the upper side of the second outer film 2b. The first outer film 2a, the first inner film 1a, the second outer film 2b and the second inner film 1b are adhered by means of hot sealing to allow an air filling passageway 9 to be formed between the first inner film 1a and the second inner film 1b and positioned on one common end of the first outer film 2a and the second outer film 2b.

A heat resistant material 1c is spread sequentially and separately between the two first inner films 1a. The two first inner films 1a are still not adhered to each other to form an air inlet 110 and a first air passageway 111 connected to the first air inlet 110 used for communicating the air filling passageway 9 with the first air chamber after hot sealing is processed. Here, the first air passageway 111 is a hot-sealing curve type and the width of one end of the first air passageway 111 connected to the first air inlet 110 is larger than the width of another end thereof. Furthermore, the first air passageway 111 can also be a multiple dots type, double curve type or straight line type air flowing route. Besides, a second air inlet 120 and a second air passageway 121 having the same structures are formed between the two second inner films 1b and used for communicating the air filling passageway 9 with the second air chamber 12.

From the structure mentioned above, when the two first inner films 1a is subject to the thrust of the inner air pressure of the first air chamber 11, the first inner films 1a might be attached closely onto the first outer film 2a or the middle film 2c, and might not be side-attached onto the first outer film 2a or the middle film 2c but become a double sheet cantilever type air enclosure and similarly, when the two second inner films 1b is subject to the thrust of the inner air pressure of the second air chamber 12, the second inner films 1b might be attached closely onto the middle film 2c or the first outer film 2a, and might not be side-attached onto the middle film 2c or the second outer film 2b but become a double-sheet cantilever type air enclosure

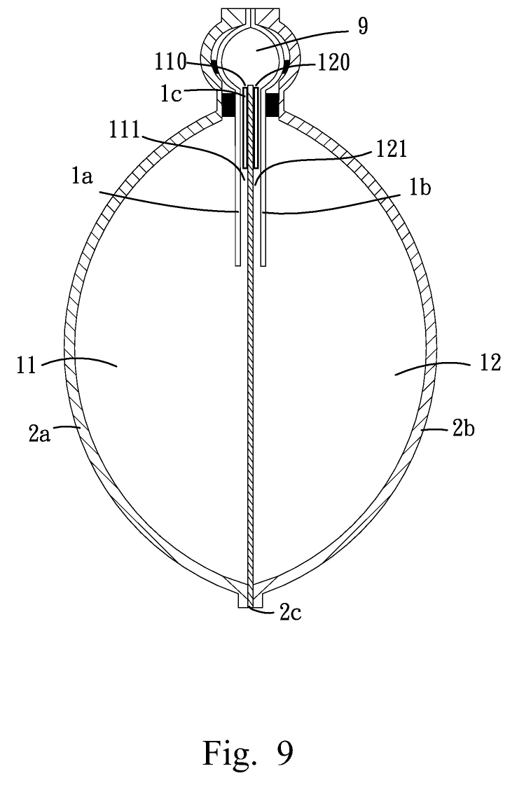

Please refer to FIG. 9. FIG. 9 is a cross sectional view, showing an air enclosure with independent double layer air chambers after air filling of a fourth preferred embodiment according to the present invention;

One first inner film 1a is disposed between the first outer film 2a and the middle 2c, and the upper side of the first inner film 1a is lined up with the upper side of the middle film 2c and similarly, one second inner film 1b is disposed between the middle film 2c and the second outer film 2b, and the upper side of the second inner film 1b is lined up with the upper side of the middle film 2c. The first outer film 2a, the first inner film 1a, the second outer film 2b and the second inner film 1b are adhered by means of hot sealing to allow an air filling passageway 9 to be formed between the first inner film 1a and the second inner film 1b and positioned on one common end of the first outer film 2a and the second outer film 2b.

A heat resistant material 1c is spread on one face of the first inner film 1a. The first inner film 1a is not adhered to other films to form a first air inlet 110 and a first air passageway 111 connected to the first air inlet 110 used for communicating the air filling passageway 9 with the first air chamber 11 even after hot sealing is processed. Here, the first air passageway 111 is a hot-sealing curve type and the width of one end of the first air passageway 111 connected to the first air inlet 110 is larger than the width of another end thereof. Furthermore, the first air passageway 111 can also be a multiple dots type, double curve type or straight line type air flowing route. Besides, a second air inlet 120 and a second air passageway 121 having the same structures are formed after one face of the second inner film 1b is spread with the heat resistant material 1c and used for communicating the air filling passageway 9 with the second air chamber 12.

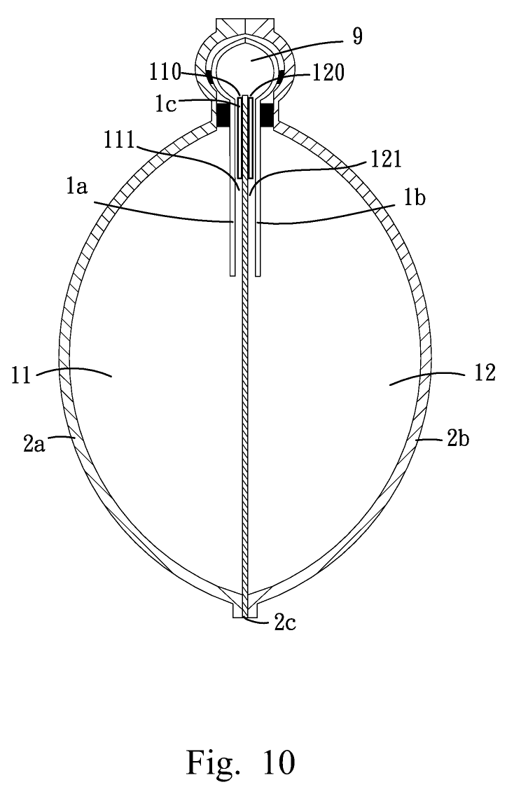

Please refer to FIG. 10. FIG. 10 is a cross sectional view, showing an air enclosure with independent double layer air chambers after air filling of a fifth preferred embodiment according to the present invention;

One first inner film 1a is disposed between the first outer film 2a and the middle 2c and one second inner film 1b is disposed between the middle film 2c and the second outer film 2b. The first outer film 2a, the first inner film 1a, the second outer film 2b and the second inner film 1b are adhered by means of hot sealing to allow an air filling passageway 9 to be formed between the first inner film 1a and the second inner film 1b and positioned on one common end of the first outer film 2a and the second outer film 2b.

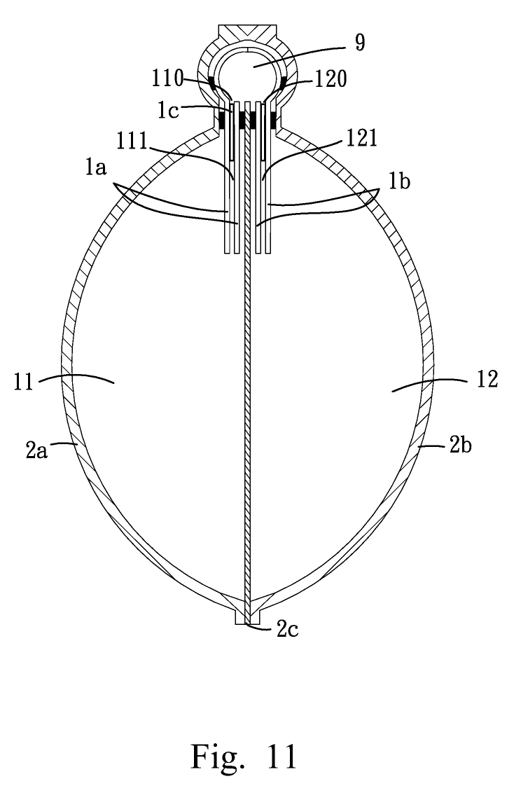

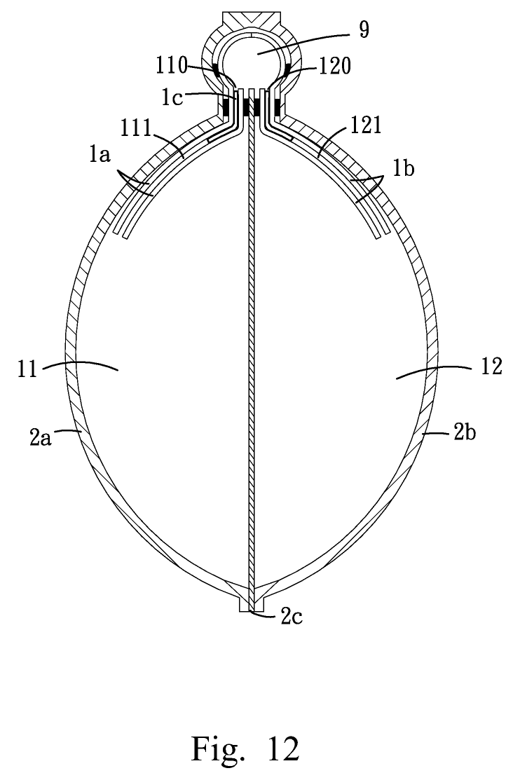

Please refer to FIGS. 11 and 12. FIG. 11 is a cross sectional view, showing an air enclosure with independent double layer air chambers after air filling of a sixth preferred embodiment according to the present invention. FIG. 12 is a cross sectional view, showing an air enclosure with independent double layer air chambers after air filling of a sixth preferred embodiment according to the present invention;

Two first inner films 1a are disposed between the first outer film 2a and the middle 2c and two second inner films 1b are disposed between the middle film 2c and the second outer film 2b. The first outer film 2a, the second outer film 2b, the first inner film 1a close to the first outer film 2a and the second inner film 1b close to the second outer film 2b are adhered by means of hot sealing to allow an air filling passageway 9 to be formed between the first inner film 1a and the second inner film 1b and positioned on one common end of the first outer film 2a and the second outer film 2b.

A heat resistant material 1c is spread sequentially and separately between the two first inner films 1a. The two first inner films 1a are still not adhered to each other to form an air inlet 110 and a first air passageway 111 connected to the first air inlet 110 used for communicating the air filling passageway 9 with the first air chamber after hot sealing is processed. Here, the first air passageway 111 is a hot-sealing curve type and the width of one end of the first air passageway 111 connected to the first air inlet 110 is larger than the width of another end thereof. Furthermore, the first air passageway 111 can also be a multiple dots type, double curve type or straight line type air flowing route. Besides, a second air inlet 120 and a second air passageway 121 having the same structures are formed between the two second inner films 1b and used for communicating the air filling passageway 9 with the second air chamber 12.

From the structure mentioned, when the two first inner films 1a is subject to the thrust of the inner air pressure of the first air chamber 11, the first inner films 1a might be attached closely onto the first outer film 2a or the middle film 2c, and might not be side-attached onto the first outer film 2a or the middle film 2c but become a double sheet cantilever type air enclosure and similarly, when the two second inner films 1b is subject to the thrust of the inner air pressure of the second air chamber 12, the second inner films 1b might be attached closely onto the middle film 2c or the first outer film 2a, and might not be side-attached onto the middle film 2c or the second outer film 2b but become a double-sheet cantilever type air enclosure.

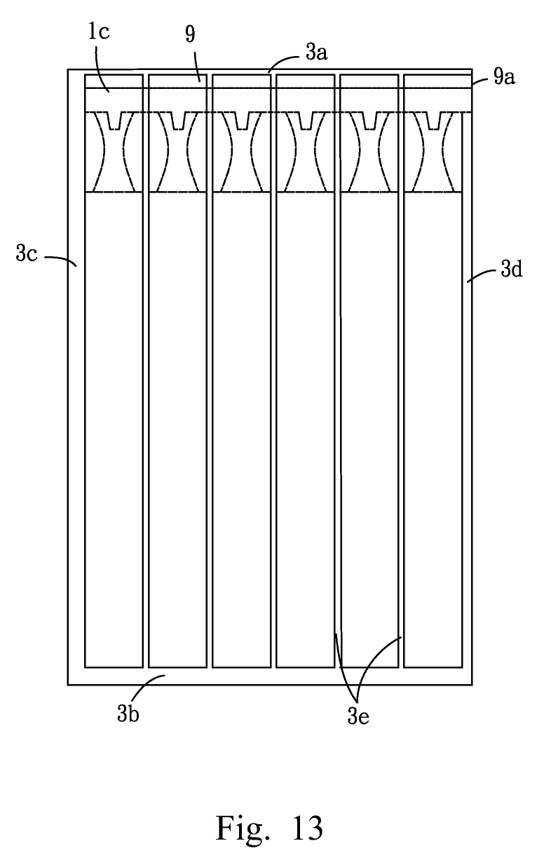

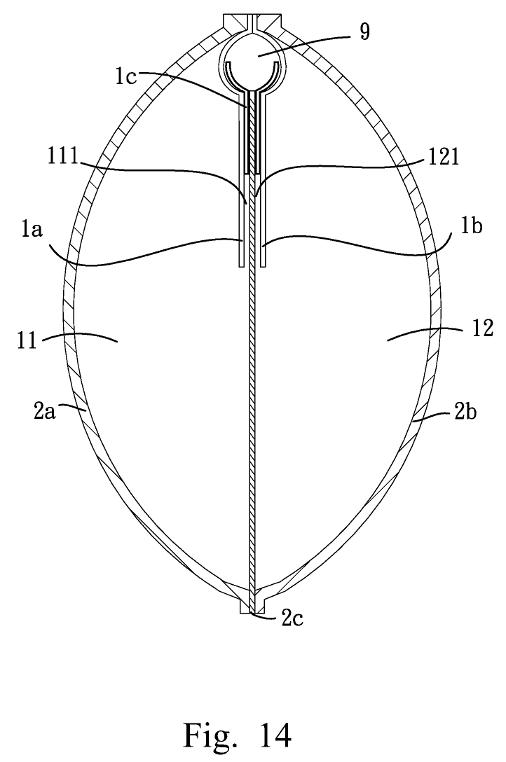

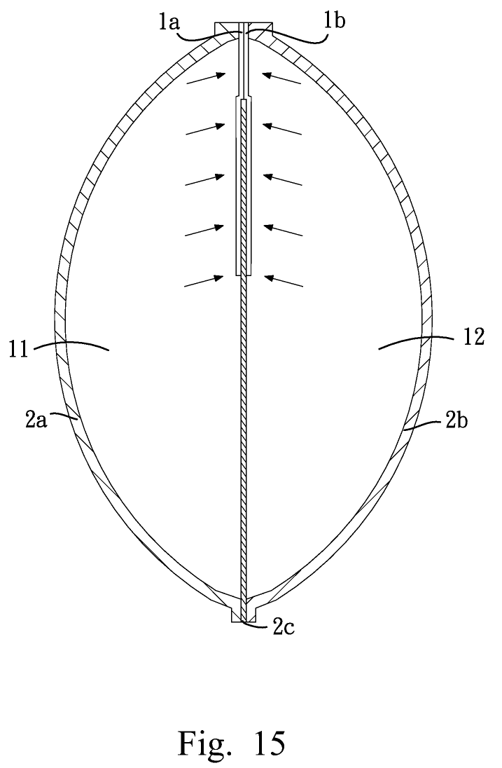

Please refer to FIGS. 13, 14 and 15. FIG. 13 is a plane view, showing an air enclosure with independent double layer air chambers before air filling of a seventh preferred embodiment according to the present invention. FIG. 14 is a cross sectional view, showing an air enclosure with independent double layer air chambers after air filling of a seventh preferred embodiment according to the present invention. FIG. 15 is a cross sectional view, showing an air enclosure with independent double layer air chambers after air filling of a seventh preferred embodiment according to the present invention.

One first inner film 1a is disposed between the first outer film 2a and the upper side of the first inner film 1a is lined up with the upper side of the first outer film 2a and similarly, the middle 2c and one second inner film 1b is disposed between the middle film 2c and the second outer film 2b and the upper side of the upper side of the second inner film 1b is lined up with the upper side of the second outer film. The upper sides of first outer film 2a, the first inner film 1a, the second outer film 2b and the second inner film 1b are adhered together by means of hot sealing and the middle portions of the first inner film 1a and the second inner film 1b are also adhered together to allow an air filling passageway 9 to be formed between the first inner film 1a and the second inner film 1b and positioned on one common end of the first outer film 2a and the second outer film 2b. One first inner film 1a is disposed between the first outer film 2a and the middle 2c and one second inner film 1b is disposed between the middle film 2c and the second outer film 2b. The first outer film 2a, the first inner film 1a, the second outer film 2b and the second inner film 1b are adhered by means of hot sealing to allow an air filling passageway 9 to be formed between the first inner film 1a and the second inner film 1b and positioned on one common end of the first outer film 2a and the second outer film 2b. In such kind structure, two first inner films 1a can also be disposed between the first outer film 2a and the middle film 2c, and the upper side of the first inner film 1a positioned closer to the first outer film 2a is lined up with the upper side of the first outer film 2a and similarly, two second inner films 1b can also be disposed between the middle film 2c and the second outer film 2b, and the upper side of the second inner film 1b positioned closer to the second outer film 2b is lined up with the upper side of the second outer film 2b.

A heat resistant material 1c is spread on one face of the first inner film 1a. The first inner film 1a is not adhered to other films to form a first air inlet 110 and a first air passageway 111 connected to the first air inlet 110 used for communicating the air filling passageway 9 with the first air chamber 11 even after hot sealing is processed. Here, the first air passageway 111 is a hot-sealing curve type and the width of one end of the first air passageway 111 connected to the first air inlet 110 is larger than the width of another end thereof. Furthermore, the first air passageway 111 can also be a multiple dots type, double curve type or straight line type air flowing route. Besides, a second air inlet 120 and a second air passageway 121 having the same structures are formed after one face of the second inner film 1b is spread with the heat resistant material 1c and used for communicating the air filling passageway 9 with the second air chamber 12.

The air entering the air filling entrance 9a expands the air filling passageway 9 to cause the first inner films 1a to be pulled outward to open each first air inlet 110 and in the meantime, cause the inner film 1b to be pulled outward to open each second air inlet 120, thereby the air in the air filling passageway 9 can be used to fill the first air chamber 11 and the second air chamber 12 with air to allow the first air chamber 11 and the second air chamber 12 to be filled with air and expanded. Thus, the inner air pressure of the first air chamber 11 presses the first inner films 1a to attach closely onto the first outer film 2a or the middle film 2c to cover the first air passageway 111 and hence, seal the first air chamber 11. Similarly, the inner air pressure of the second air chamber 12 presses the second inner films 1b to attach closely onto the middle film 2c or the second outer film 2b to cover the second air passageway 121 and hence, seal the second air chamber 12. Moreover, the inner air pressure in the first air chamber 11 and the second air chamber 12 might also simultaneously press the first inner film 1a and the second inner film 1b to cause the air filling passageway 9 to be thrust to seal. Whereby, the air in the first air chamber 11 and the second air chamber 12 are allowed not to be leaked out to attain to the air locking effect.

According to the structure disclosed by the present invention, the air filling passageway 9 can be connected to one first air inlet 110 or connected with the plurality of first air inlets 110; each first air chamber 11 can be connected to one first air passageway 111 or connected with the plurality of first air passageways 111, and each two first air chambers 11 can be communicated with each other and can further share one first air passageway 111 or the plurality of first air passageways 111. furthermore, the air filling passageway 9 can be connected to one second air inlet 120 or connected with the plurality of second air inlets 120; each second air chamber 12 can be connected to one second air passageway 121 or connected with the plurality of second air passageways 121, and each two second air chambers 12 can be communicated with each other and can further share one second air passageway 121 or the plurality of second air passageways 121.

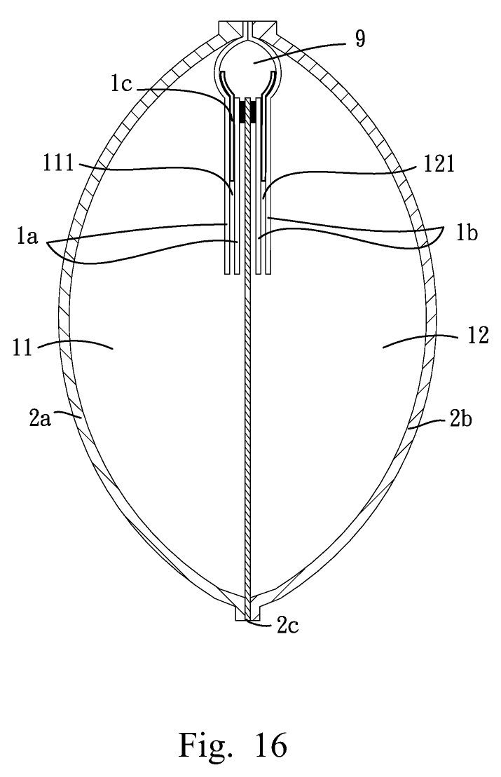

Please refer to FIG. 16. FIG. 16 is a cross sectional view, showing an air enclosure with independent double layer air chambers after air filling of a eighth preferred embodiment according to the present invention;

Two first inner films 1a are disposed between the first outer film 2a and the middle film 2c, and the upper side of the first inner film 1a positioned closer to the first outer film 2a is lined up with the upper side of the first outer film 2a and similarly, two second inner films 1b are disposed between the middle film 2c and the second outer film 2b, and the upper side of the second inner film 1b positioned closer to the second outer film 2b is lined up with the upper side of the second outer film 2b. The first outer film 2a, the first inner film 1a, the second outer film 2b and the second inner film 1b are adhered by means of hot sealing to allow an air filling passageway 9 to be formed between the first inner film 1a and the second inner film 1b and positioned on one common end of the first outer film 2a and the second outer film 2b.

A heat resistant material 1c is spread sequentially and separately between the two first inner films 1a. The two first inner films 1a are still not adhered to each other to form an air inlet 110 and a first air passageway 111 connected to the first air inlet 110 used for communicating the air filling passageway 9 and the first air chamber 11 after hot sealing is processed. Here, the first air passageway 111 is a hot-sealing curve type and the width of one end of the first air passageway 111 connected to the first air inlet 110 is larger than the width of another end thereof. Furthermore, the first air passageway 111 can also be a multiple dots type, double curve type or straight line type air flowing route. Besides, a second air inlet 120 and a second air passageway 121 having the same structures are formed between the two second inner films 1b and used for communicating the air filling passageway 9 with the second air chamber 12.

The air entering the air filling entrance 9a expands the air filling passageway 9 to cause the two first inner films 1a to be pulled outward to open the first air inlet 110 and in the meantime, cause the two second inner films 1b to be pulled outward to open the second air inlet 120, thereby the air in the air filling passageway 9 can be used to fill the first air chamber 11 and the second air chamber 12 with air to allow each first air chamber 11 and each second air chamber 12 to be filled with air and expanded. Thus, the inner air pressure of the first air chamber 11 presses the two first inner films 1a to attach closely onto the first outer film 2a or the middle film 2c to cover the first air passageway 111 and hence, seal the first air chamber 11. Similarly, the inner air pressure of the second air chamber 12 presses the two second inner films 1b to attach closely onto the middle film 2c or the second outer film 2b to cover the second air passageway 121 and hence, seal the second air chamber 12. Whereby, the air in the first air chamber and the second air chamber 12 are allowed not to be leaked out to attain to the double air locking effect.

From the structure mentioned, when the two first inner films 1a is subject to the thrust of the inner air pressure of the first air chamber 11, the first inner films 1a might be attached closely onto the first outer film 2a or the middle film 2c, and might not be side-attached onto the first outer film 2a or the middle film 2c but become a double sheet cantilever type air enclosure and similarly, when the two second inner films 1b is subject to the thrust of the inner air pressure of the second air chamber 12, the second inner films 1b might be attached closely onto the middle film 2c or the first outer film 2a, and might not be side-attached onto the middle film 2c or the second outer film 2b but become a double-sheet cantilever type air enclosure.

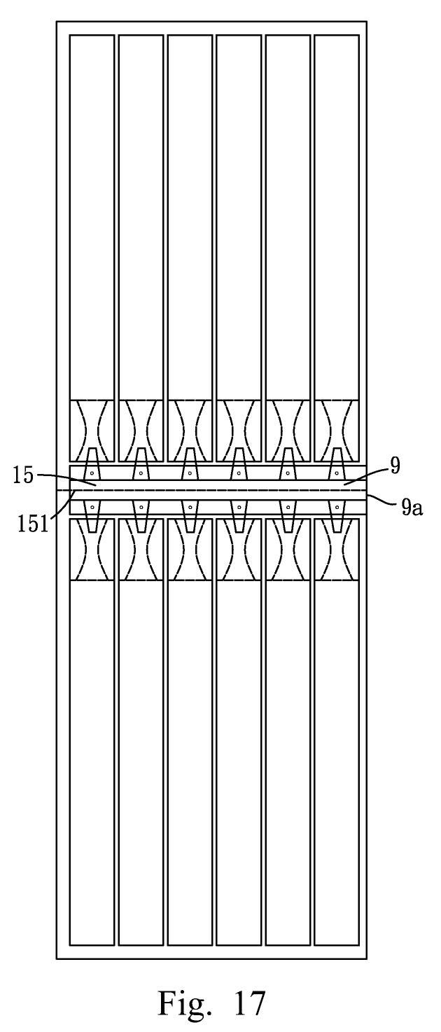

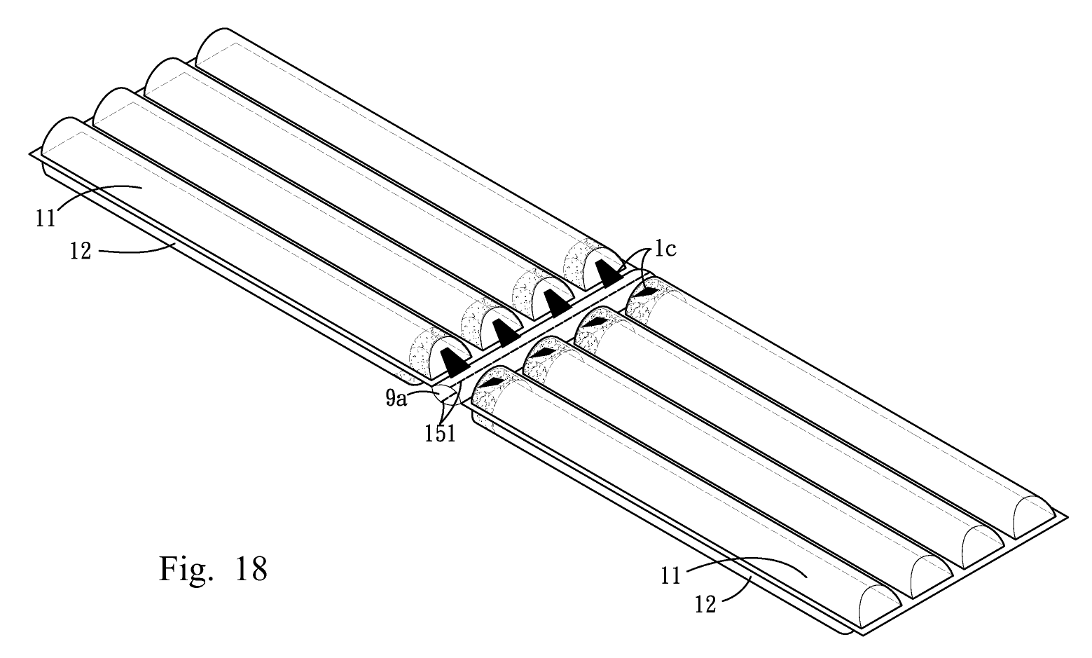

Please refer to FIGS. 17 and 18. FIG. 17 is a plane view, showing an air enclosure with independent double layer air chambers before air filling of a ninth preferred embodiment according to the present invention. FIG. 18 is a cross sectional view, showing an air enclosure with independent double layer air chambers after air filling of a ninth preferred embodiment according to the present invention.

An air filling passageway 9 is positioned at a place in the middle of an inner films 2a and an second outer film 2b, and a plurality of first air chambers 11 and a plurality of second air chambers 12 are formed at two ends of the air filling passageway 9. When air is filled, the air in the air filling passageway 9 is filled into the first air chambers 11 and the second air chambers 12 at the same time to attain to the air filling time reduction purpose.

Furthermore, a cutting zone 15 is disposed on the air filling passageway 9 to allow the air chambers at the both ends of the air filling passageway 9 to be separated by cutting along a cutting line 151 on the cutting zone 15 after air is filled; this allows the product output of the air enclosures to be double.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents

What is claimed is:

1. An air enclosure with independent double layer air chambers, comprising:
a first outer film;
a second outer film, folded with the first outer film;
at least one middle film, disposed between the first outer film and the second outer film, a length of the middle film being shorter than the first outer film and the second outer film, and one side of the middle film being lined up with one common side of the first outer film and the second outer film;
an air filling passageway, being an air passable space formed by adhering the first outer film to the second outer film together by means of hot sealing;
a plurality of first air chambers, positioned at one side of the air filling passageway and being air storable spaces formed by adhering the first outer film to the middle film by means of hot sealing;
at least one first air inlet, formed between the first outer film and the middle film and used for communicating the air filling passageway with the first air chambers;
a plurality of second air chambers, positioned at one side of the air filling passageway and being air storable spaces formed by adhering the middle film to the second outer film by means of hot sealing; and
at least one second air inlet, formed between the middle film and the second outer film and used for communicating the air filling passageway with the second air chambers;
wherein, air in the air filling passageway is filled into the first air chambers to expand the first air chambers via the first air inlets and in the meantime, filled into the second air chambers to expand the second air chambers via the second air inlets.

2. The air chamber according to claim 1, further comprising at least one first inner film positioned between the first outer film and the middle film.

3. The air enclosure according to claim 2, wherein a upper side of the first inner film is lined up with a upper side of the middle film.

4. The air enclosure according to claim 1, wherein a heat resistant material is spread on one face of the first inner film, the first air inlet is formed by not being adhered to other films even by means of hot sealing.

5. The air enclosure according to claim 1, wherein the first air chamber comprises a first air passageway connected to the first air inlet.

6. The air enclosure according to claim 1, further comprising at least one second inner film positioned between the middle film and the second outer film.

7. The air enclosure according to claim 6, wherein a upper side of the second inner film is lined up with a upper side of the middle film.

8. The air enclosure according to claim 6, wherein a heat resistant material is spread on one face of the second inner film, the second air inlet is formed by being not adhered to other films by means of hot sealing.

9. The air enclosure according to claim 1, wherein the second air chamber comprises a second air passageway connected to the second air inlet.

10. The air enclosure according to claim 1, wherein the air filling passageway is positioned on one common end of the first outer film and the second outer film or a common middle positions of the first outer film and the second outer film.

11. The air enclosure according to claim 1, further comprising a cutting zone positioned on the air filling passageway, the first air chambers and the second air chambers at the two ends of the air filling passageway being allowed to separate from each other by cutting along the cutting zone.

12. An air enclosure with independent double layer air chambers, comprising:
a first outer film;
a second outer film, folded with the first outer film;
at least one middle film, disposed between the first outer film and the second outer film, a length of the middle film being shorter than the first outer film and the second outer film, and one side of the middle film being lined up with one common side of the first outer film and the second outer film;
at least one first inner film, positioned between the first outer film and the middle film;
at least one second inner film, positioned between the middle film and the second outer film;
an air filling passageway, being an air passable space formed by adhering the first outer film to the second outer film together by means of hot sealing;
a plurality of first air chambers, positioned at one side of the air filling passageway and being air storable spaces formed by adhering the first outer film to the middle film by means of hot sealing;
at least one first air inlet, formed between the first outer film and the middle film and used for communicating the air filling passageway with the first air chambers;
a plurality of second air chambers, positioned at one side of the air filling passageway and being air storable spaces formed by adhering the middle film and to second outer film by means of hot sealing; and
at least one second air inlet, formed between the middle film and the second outer film and used for communicating the air filling passageway with the second air chambers;
wherein, air in the air filling passageway is filled into the first air chambers to expand the first air chambers via the first air inlets and in the meantime, filled into the second air chambers to expand the second air chambers via the second air inlets.

13. The air enclosure according to claim 12, wherein a upper side of the first inner film is lined up with a upper side of the middle film.

14. The air enclosure according to claim 12, wherein a heat resistant material is spread on one face of the first inner film, the first air inlet is formed by not being adhered to other films even by means of hot sealing.

15. The air enclosure according to claim 12, wherein the first air chamber comprises a first air passageway connected to the first air inlet.

16. The air enclosure according to claim 12, wherein a upper side of the second inner film is lined up with a upper side of the middle film.

17. The air enclosure according to claim 12, wherein a heat resistant material is spread on one face of the second inner film, the second air inlet is formed by being not adhered to other films by means of hot sealing.

18. The air enclosure according to claim 12, wherein the second air chamber comprises a second air passageway connected to the second air inlet.

19. The air enclosure according to claim 12, wherein the air filling passageway is positioned on one common end of the first outer film and the second outer film or a common middle positions of the first outer film and the second outer film.

20. The air enclosure according to claim 1, further comprising a cutting zone positioned on the air filling passageway, the first air chambers and the second air chambers at the two ends of the air filling passageway being allowed to separate from each other by cutting along the cutting zone.
